(19) United States
(12) Patent Application Publication
(10) Pub. No.: US 2012/0002634 A1
(43) Pub. Date: Jan. 5, 2012

(54) METHOD OF ALLOCATING RADIO RESOURCE

(76) Inventor: Yong Ho Seok, Anyang-si (KR)

(21) Appl. No.: 13/256,871

(22) PCT Filed: Sep. 23, 2009
(86) PCT No.: PCT/KR2009/005423

§ 371 Date: Sep. 15, 2011

Related U.S. Application Data
(60) Provisional application No. 61/160,351, filed on Mar. 16, 2009.

(30) Foreign Application Priority Data
Aug. 13, 2009 (KR) 10-2009-0074818

(51) Int. Cl. H04W 72/04; H04W 84/02

(52) U.S. Cl. 370/329

(57) ABSTRACT

A method of allocating a radio resource is provided. The method includes: receiving space division multiple access (SDMA) information for downlink transmission; transmitting a result of channel estimation performed on channels corresponding to data streams transmitted in downlink according to the SDMA information; and receiving the data streams through the respective channels according to the result of channel estimation. Accordingly, radio resource request states of stations can be collectively considered.

### TECHNICAL FIELD

The present invention relates to a wireless local area network (WLAN), and more particularly, to a method of allocating a radio resource in a very high throughput (VHT) WLAN system.

### BACKGROUND ART

With the advancement of information communication technologies, various wireless communication technologies have recently been developed. Among the wireless communication technologies, a wireless local area network (WLAN) is a technology whereby Internet access is possible in a wireless fashion in homes or businesses or in a region providing a specific service by using a portable terminal such as a personal digital assistant (PDA), a laptop computer, a portable multimedia player (PMP), etc.

Ever since the institute of electrical and electronics engineers (IEEE) 802, i.e., a standardization organization for WLAN technologies, was established in February 1980, many standardization works have been conducted.

In the initial WLAN technology, a frequency of 2.4 GHz was used according to the IEEE 802.11 to support a data rate of 1 to 2 Mbps by using frequency hopping, spread spectrum, infrared communication, etc. Recently, the WLAN technology can support a data rate of up to 54 Mbps by using orthogonal frequency division multiplex (OFDM). In addition, the IEEE 802.11 is developing or commercializing standards of various technologies such as quality of service (QoS) improvement, access point (AP) protocol compatibility, security enhancement, radio resource measurement, wireless access in vehicular environments, fast roaming, mesh networks, inter-working with external networks, wireless network management, etc.

In the IEEE 802.11, the IEEE 802.11a supports a data rate of up to 11 Mbps by using a frequency band of 2.4 GHz. The IEEE 802.11a commercialized after the IEEE 802.11b uses a frequency band of 5 GHz instead of the frequency band of 2.4 GHz and thus significantly reduces influence of interference in comparison with the very congested frequency band of 2.4 GHz. In addition, the IEEE 802.11a has improved the data rate to up to 54 Mbps by using the OFDM technology. Disadvantageously, however, the IEEE 802.11a has a shorter communication distance than the IEEE 802.11b. Similarly to the IEEE 802.11b, the IEEE 802.11g implements the data rate of up to 54 Mbps by using the frequency band of 2.4 GHz. Due to its backward compatibility, the IEEE 802.11g is drawing attention, and is advantageous over the IEEE 802.11a in terms of the communication distance.

The IEEE 802.11n is a technical standard relatively recently introduced to overcome a limited data rate which has been considered as a drawback in the WLAN. The IEEE 802.11n is devised to increase network speed and reliability and to extend an operational distance of a wireless network.

More specifically, the IEEE 802.11n supports a high throughput (HT), i.e., a data processing speed of up to 540 Mbps at a frequency band of 5 GHz, and is based on a multiple input and multiple output (MIMO) technique which uses multiple antennas in both a transmitter and a receiver to minimize a transmission error and to optimize a data rate.

In addition, this standard may use a coding scheme which transmits several duplicated copies to increase data reliability and also may use the OFDM to support a higher data rate.

With the widespread use of the WLAN and the diversification of applications using the WLAN, there is a recent demand for a new WLAN system to support a higher throughput than a data processing speed supported by the IEEE 802.11n. A very high throughput (VHT) system is one of IEEE 802.11 WLAN systems which have recently been proposed to support a data processing speed of 1 Gbps or more. The VHT system is named arbitrarily. To provide a throughput of 1 Gbps or more, a feasibility test is currently being conducted for the VHT system which uses 4×4 MIMO and a channel bandwidth of 80 MHz or more and which also uses a spatial division multiple access (SDMA) scheme as a channel access scheme.

The conventional channel access mechanism used in the IEEE 802.11n WLAN system or other WLAN systems cannot be directly used as a channel access mechanism of a WLAN system for providing a throughput of 1 Gbps or more (hereinafter, such a WLAN system is referred to as a VHT WLAN system). This is because a channel bandwidth used by the VHT WLAN system is at least 80 MHz since the conventional WLAN system operates under the premise of using a channel bandwidth of 20 MHz or 40 MHz which is too narrow to achieve the throughput of 1 Gbps or more in a service access point (SAP).

Therefore, in order for a VHT basic service set (BSS) to satisfy a total throughput of 1 Gbps or more, several VHT STAs need to simultaneously use a channel in an effective manner. A VHT AP uses SDMA to allow the several VHT STAs to simultaneously use the channel in an effective manner. That is, the several VHT STAs are allowed to simultaneously transmit and receive data to and from the VHT AP. For this, the VHT AP needs to have more physical (PHY) interfaces than the VHT STAs. That is, the VHT AP requires a larger number of antennas than the VHT STA.

For example, in a case where the VHT STAs have 4 PHY interfaces and the VHT AP has 8 PHY interfaces, if one VHT STA transmits 4 data streams to the VHT AP, up to 2 VHT STAs can simultaneously transmit the data streams to the VHT AP. If one VHT STA transmits and receives 2 data streams to and from the VHT AP, up to 4 VHT STAs can simultaneously transmit and receive the data streams to and from the VHT AP.

The PHY interfaces need to be dynamically distributed to the respective VHT STAs so that the VHT system can optimize radio resource utilization. For example, it is assumed that a VHT SP STA has 8 VHT interfaces and a VHT non-AP STA has 4 PHY interfaces. 4 VHT non-AP STAs can simultaneously communicate with the VHT AP STA when the VHT AP STA allows the VHT STAs to use up to 2 PHY interfaces. This is because the VHT AP supports only up to 8 streams by using SDMA.

In this case, the VHT AP may collectively consider the number of action categories (AC) of data to be transmitted by each VHT STA and the number of VHT STAs contending each other.

### DISCLOSURE OF INVENTION

### Technical Problem

The present invention provides a method of allocating a radio resource and a method of transmitting data according to the number of radio resources that can be allocated or the number of interfaces when data is transmitted through multiple antennas in a wireless local area network (WLAN) environment. In the present invention, the radio resources are requested and allocated by collectively considering a data transfer amount of separate stations contending with each other.

### Technical Solution

According to an aspect of the present invention, method of allocating a radio resource includes: receiving space division multiple access (SDMA) information for downlink transmission; transmitting a result of channel estimation performed on channels corresponding to data streams transmitted in downlink according to the SDMA information; and receiving the data streams through the respective channels according to the result of channel estimation.

According to another aspect of the present invention, a method of allocating a radio resource includes: in a contention-based channel access process, transmitting information indicating the number of data streams to be transmitted in uplink to an access point (AP); receiving radio resource allocation information comprising information indicating the number of physical (PHY) interfaces to be used to receive the data streams; and allocating the radio resource according to a smaller value between the number of data streams and the number of PHY interfaces.

According to still another aspect of the present invention, a terminal for performing radio resource allocation and data transmission in a wireless local area network (WLAN) system, includes: a processor; and a radio frequency (RF) unit, wherein the RF unit transmits information indicating the number of data streams generated by the processor and to be transmitted in uplink and receives radio resource allocation information, and the processor controls transmission of the data stream corresponding to an allocated interface according to the radio resource allocation information.

### Advantageous Effects

According to embodiments of the present invention, information indicating an amount of required radio resources and information indicating an amount of data to be transmitted in a channel access process are shared in advance, and thus radio resource utilization and request states can be collectively considered in stations existing in a wireless communication system. In addition, since information indicating an amount of available radio resources is obtained in advance by the stations, unnecessary contention and transmission of control signals can be prevented. Further, overhead or waste of resources can be prevented.

### BRIEF DESCRIPTION OF DRAWINGS

FIG. 1 is a schematic view showing an exemplary structure of a very high throughput (VHT) wireless local area network (WLAN) system according to an embodiment of the present invention.

FIG. 2 is a flowchart showing a method of allocating a radio resource for downlink transmission according to an embodiment of the present invention.

FIG. 3 shows an example of space division multiple access (SDMA) information transmitted according to the embodiment shown in FIG. 2.

FIG. 4 is a flowchart showing a method of allocating a radio resource for uplink transmission according to an embodiment of the present invention.

FIG. 5 shows an example of a request to send (RTS) frame transmitted according to the embodiment shown in FIG. 4.

FIG. 6 shows an example of a clear to send (CTS) frame transmitted according to the embodiment shown in FIG. 4.

FIG. 7 shows a method of allocating a radio resource for uplink transmission and a method of transmitting a data stream according to another embodiment of the present invention.

FIG. 8 shows an example of an SDMA information frame transmitted in the embodiment shown in FIG. 4 or FIG. 7.

FIG. 9 is a block diagram of a terminal for performing a radio resource allocation method according to an embodiment of the present invention.

### MODE FOR THE INVENTION

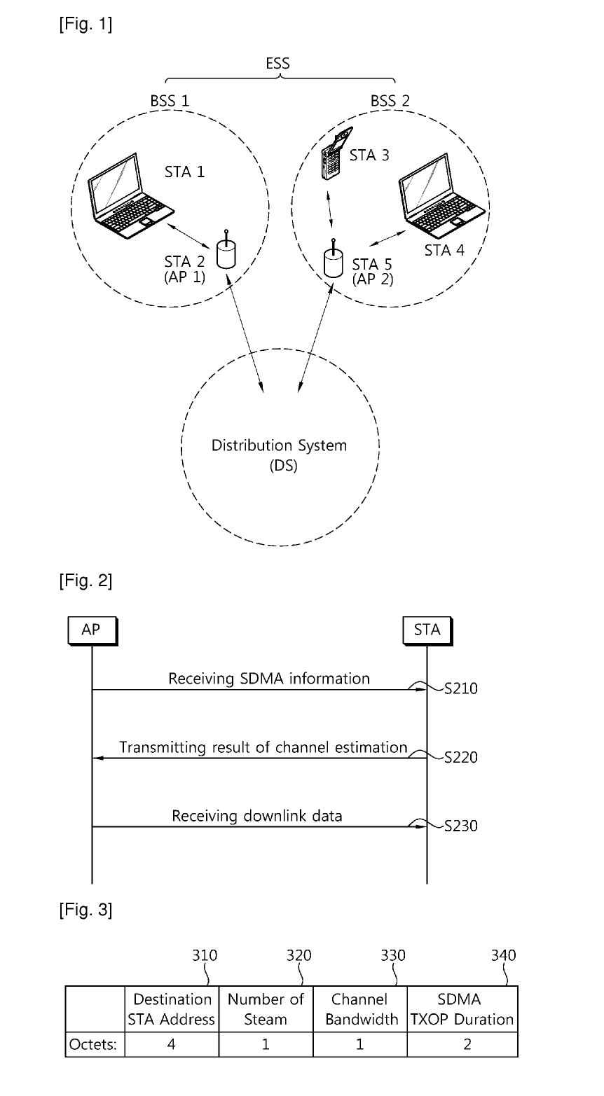

FIG. 1 is a schematic view showing an exemplary structure of a very high throughput (VHT) wireless local area network (WLAN) system according to an embodiment of the present invention.

Referring to FIG. 1, a WLAN system such as the VHT WLAN system includes one or more basis service sets (BSSs). The BSS is a set of stations (STAs) which are successfully synchronized to communicate with one another, and is not a concept indicating a specific region. As in the WLAN system to which the embodiment of the present invention is applicable, a BSS that supports a super high-speed data processing of 1 GHz or more is referred to as a VHT BSS.

The VHT BSS can be classified into an infrastructure BSS and an independent BSS (IBSS). The infrastructure BSS is shown in FIG. 1.

Infrastructure BSSs (i.e., BSS1 and BSS2) include one or more non-access point (AP) STAs (i.e., Non-AP STA1, Non-AP STA3, and Non-AP STA4) which are STAs providing a distribution service, APs (i.e., AP 1 (STA 2) and AP 2 (STA 5) which are STAs providing a distribution service, and a distribution system (DS) connecting the plurality of APs (i.e., AP 1 (STA 2) and AP 2 (STA 5)). In the infrastructure BSS, an AP STA manages the non-AP STAs.

On the other hand, the IBSS is a BSS operating in an ad-hoc mode. Since the IBSS does not include the VHT STA, a centralized management entity for performing a management function in a centralized manner does not exist. That is, the IBSS manages the non-AP STAs in a distributed manner. In addition, in the IBSS, all STAs may consist of mobile STAs, and a self-contained network is configured since connection to the DS is not allowed.

The STA is an arbitrary functional medium including a medium access control (MAC) and wireless-medium physical layer (PHY) interface conforming to the institute of electrical and electronics engineers (IEEE) 802.11 standard, and includes both an AP and a non-AP STA in a broad sense. A VHT STA is defined as an STA that supports the super high-speed data processing of 1 GHz or more in the multichannel environment to be described below. In the VHT WLAN system to which the embodiment of the present invention is applicable, STAs included in the BSS may be all VHT STAs, or a VHT STA and a legacy STA (i.e., IEEE 802.11n-based HT STA) may coexist.

The STA for wireless communication includes a processor and a transceiver, and also includes a user interface, a display means, etc. The processor is a functional unit devised to generate a frame to be transmitted through a wireless network or to process a frame received through the wireless network, and performs various functions to control STAs. The transceiver is functionally connected to the processor and is a functional unit devised to transmit and receive a frame for the STAs through the wireless network.

Among the STAs, non-AP STAs (i.e., STA1, STA3, STA4, and STA5) are portable terminals operated by users. A non-AP STA may be simply referred to as an STA. The non-AP STA may also be referred to as a terminal, a wireless transmit/receive unit (WTRU), a user equipment (UE), a mobile station (MS), a mobile terminal, a mobile subscriber unit, etc. A non-AP VHT-STA (or simply VHT STA) is defined as a nonAP STA that supports the super high-speed data processing of 1 GHz or more in the multi-channel environment to be described below.

The AP (i.e., AP1 and AP2) is a functional entity for providing connection to the DS through a wireless medium for an associated STA. Although communication between non-AP STAs in an infrastructure BSS including the AP is performed via the AP in principle, the non-AP STAs can perform direct communication when a direct link is set up. In addition to the terminology of an access point, the AP may also be referred to as a centralized controller, a base station (BS), a node-B, a base transceiver system (BTS), a site controller, etc. A VHT AP is defined as an AP that supports the super high-speed data processing of 1 GHz or more in the multi-channel environment to be described below.

A plurality of infrastructure BSSs can be interconnected by the use of the DS. An extended service set (ESS) is a plurality of BSSs connected by the use of the DS. STAs included in the ESS can communicate with one another. In the same ESS, a non-AP STA can move from one BSS to another BSS while performing seamless communication.

The DS is a mechanism whereby one AP communicates with another AP. By using the DS, an AP may transmit a frame for STAs associated with a BSS managed by the AP, or transmit a frame when any one of the STAs moves to another BSS, or transmit a frame to an external network such as a wired network. The DS is not necessarily a network, and has no limitation in its format as long as a specific distribution service specified in the IEEE 802.11 can be provided. For example, the DS may be a wireless network such as a mesh network, or may be a physical construction for interconnecting APs.

FIG. 2 is a flowchart showing a method of allocating a radio resource for downlink transmission according to an embodiment of the present invention.

In the radio resource allocation method of the present invention, an STA receives space division multiple access (SDMA) information for downlink transmission from an AP (S210). The SDMA information includes information indicating the number of PHY interfaces through which a data stream is transmitted, i.e., information indicating the number of data streams to be transmitted. Further, the SDMA information may further include information indicating a channel bandwidth to be used for downlink transmission of the data stream.

Upon receiving the SDMA information, the STA transmits a result of channel estimation performed on channels corresponding to data streams to be transmitted in downlink (S220). Channel estimation and transmission of the result of channel estimation can be performed before transmission of the SDMA information. The AP transmits the data stream through each channel according to the result of channel estimation (S230). If a channel correlation is high between channels through which a plurality of data streams are simultaneously transmitted or if there are channels which can act as interference to each other, the AP can change its channel to a channel with a low channel correlation or can change a transmission time.

FIG. 3 shows an example of SDMA information transmitted according to the embodiment shown in FIG. 2.

The SDMA information may have a format of an SDMA information frame. The

SDMA information frame may include various fields, such as a Destination STA Address field 310, a Number of Data Stream field 320, a Channel Bandwidth field 330, an SDMA transmission opportunity (TXOP) Duration field 340, etc.

The Destination STA Address field 310 indicates MAC address information of an STA for receiving the SDMA information frame and for receiving a downlink data stream. The Number of Data Stream field 320 indicates the number of data streams to be simultaneously transmitted in downlink from the AP to the STA. That is, the Number of Data Stream field 320 indicates the number of transmission (TX) interfaces.

Therefore, by using the Number of Data Stream field 320, the STA can know a radio resource (i.e., the number of PHY interfaces) to be used by the AP to transmit a data stream. The Channel Bandwidth field 330 includes information indicating a channel bandwidth to be used by the AP to transmit the data stream. The SDMA TXOP Duration field 340 indicates a duration of downlink TXOP.

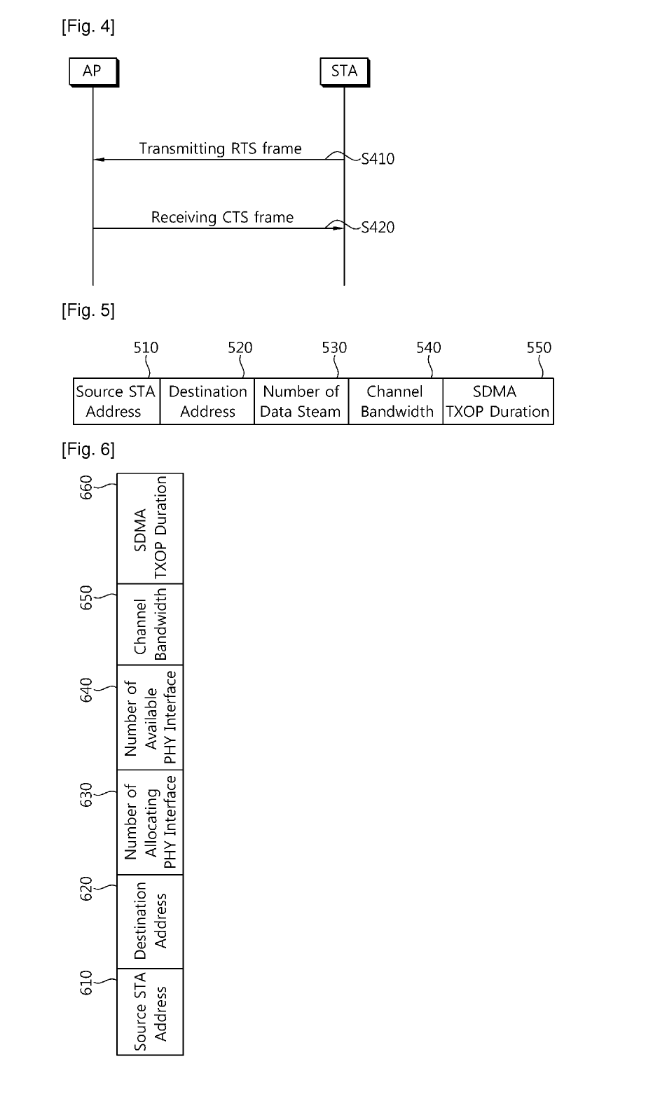

FIG. 4 is a flowchart showing a method of allocating a radio resource for uplink transmission according to an embodiment of the present invention. A process in which an AP allocates a radio resource to an STA for uplink data transmission will be described by relating the AP and the STA in a one-to-one manner with reference to the embodiment of FIG. 4.

A contention-based channel access process is premised in the embodiment of the present invention. First, the STA transmits, to the AP, information indicating the number of data streams to be transmitted in uplink. The information indicating the number of data streams may be transmitted by being included in a request to send (RTS) frame which is transmitted by the STA to the AP for the contention-based channel access (S410). In doing so, the STA may report the number of available data streams to be transmitted to the AP, or may request a required amount of radio resources, in particular, PHY interfaces.

Further, the STA receives information regarding a radio resource allocated from the AP. The radio resource allocation information received by the STA includes information indicating the number of PHY interfaces to be used by the AP to receive a data stream from the STA. This information may be referred to as PHY interface allocation information. The radio resource allocation information may also include the number of PHY interfaces that can be allocated by the AP afterwards. This can be expressed by the number of available PHY interfaces. The number of available PHY interfaces is obtained by subtracting the number of PHY interfaces allocated to the STA from the number of PHY interfaces that can be allocated by the AP.

The STA is allocated with a radio resource according to a smaller value between the number of data streams and the number of PHY interfaces to be allocated by the AP. That is, the number of PHY interfaces allocated to the STA is a smaller value between the number of PHY interfaces desired to be used by the STA and the number of PHY interfaces that can be allocated by the AP.

The PHY interface allocation information or the radio resource allocation information including information indicating the number of available PHY interfaces may be transmitted by being included in a clear to send (CTS) frame (S420). The CTS frame is transmitted in response to the RTS frame. The RTS/CTS frame will be described in brief.

In the contention-based channel access process, the AP exchanges an RTS frame and a CTS frame with STAs before transmission of a data frame, or broadcasts a CTS-to-self frame. In particular, when the data frame is transmitted in a multicast manner, the AP can report a method of transmitting a multicast frame by exchanging the RTS frame/CTS frame or by broadcasting the CTS-to-self frame. In addition, for other terminals unregistered to a multicast group or for legacy terminals, the AP can allow a network allocation vector (NAV) to be configured while the multicast frame is transmitted. As the RTS frame is transmitted, a process of transmitting the data stream is started and a transfer mode (e.g., an omni-direction mode or a directivity mode) of the data frame can be reported. The AP may transmit the CTS frame in order to report that a region is clear.

Thereafter, the STA may transmit the data stream in uplink to the AP by using the allocated radio resource. Further, the AP may transmit SDMA information. The SDMA information includes information indicating existence of radio resources that can be allocated afterwards, information indicating an amount of radio resources if there are available radio resources, information indicating a duration of next TXOP, etc. The SDMA information will be described below in greater detail with reference to FIG. 8.

FIG. 5 shows an example of an RTS frame transmitted according to the embodiment shown in FIG. 4.

As described above, the RTS frame is transmitted by an STA to an AP for contention-based channel access, and includes information indicating the number of data streams according to the embodiment of the present invention. The information indicating the number of data streams may be included in a Number of Data Stream field to be described below.

The RTS frame transmitted according to the embodiment of the present invention may include a Source STA Address field 510, a Destination Address field 520, a Number of Data Stream field 530, a Channel Bandwidth field 540, an SDMA TXOP Duration field 550, etc.

The Source STA Address field 510 indicates an MAC address of a TX STA which transmits the RTS frame. That is, the Source STA Address field 510 indicates an address of an RTS frame transmitter. The Destination Address field 520 may indicate an MAC address of an AP for receiving the RTS frame.

The Number of Data Stream field 530 includes information indicating the number of data streams to be transmitted in uplink by the STA. The information indicating the number of data streams can indicate the number of radio resources to be allocated by the STA, in particular, the number of PHY interfaces. The Channel Bandwidth field 540 may include information indicating a channel bandwidth to be used or allocated by the STA to transmit the data stream.

The SDMA TXOP Duration field 550 indicates a duration of TXOP capable of performing uplink transmission from the STA to the AP. That is, STAs can transmit uplink data streams during a duration of SDMA TXOP. This field is for exemplary purposes only and may not be included in the RTS frame. If the duration of SDMA TXOP is set to 0 in this field, the STA reconfigures a network allocation vector (NAV).

FIG. 6 shows an example of a CTS frame transmitted according to the embodiment shown in FIG. 4.

Upon receiving an RTS frame from an STA, an AP transmits the CTS frame in response to the RTS frame. The CTS frame transmitted according to the embodiment of the present invention includes a Source STA Address field 610, a Destination Address field 620, a Number of Allocating PHY Interface field 630, a Number of Available PHY Interface field 640, a Channel Bandwidth field 650, and an SDMA TXOP Duration field 660.

The Source STA Address field 610 indicates an MAC address of the AP, that is, a CTS frame transmitter of the CTS frame. The Destination Address field 620 indicates an MAC address of the STA for receiving the CTS frame.

The Number of Allocating PHY Interface field 630 indicates the number of data streams to be simultaneously received by the AP, and also indicates the number of receive (RX) interfaces to be allocated for data streams transmitted in uplink by the AP from the STA. For reference, these numbers are different in concept from the total number of radio resources that can be allocated.

A smaller value between the number of streams included in the RTS frame and the number of allocating PHY interfaces included in the CTS frame is the number of PHY interfaces finally allocated to the STA. For example, it is assumed that the STA sets a value of the Number of Data Stream field of the RTS frame to 4 and transmits the value to the AP. If two PHY interfaces are still available and thus can be allocated to the AP having a total of 8 PHY interfaces, a value of the Number of Allocating PHY Interface field is set to 2 in the CTS frame when responding to the STA. The reason above is that only two PHY interfaces can be allocated in comparison with the number of PHY interfaces actually occupied by the AP, and thus it is not possible to support all PHY interfaces required by the STA.

The Number of Available PHY Interface field 640 indicates the number of data streams that can be simultaneously received by the AP, that is, the number of RX interfaces remained unallocated. Further, the Channel Bandwidth field 650 includes information indicating a channel bandwidth to be used by the AP to receive uplink data. If a value of the Number of Available PHY interface field 640 included in the CTS frame is 0, this implies that all PHY interfaces occupied by the AP are allocated to the STAs. Therefore, a process of allocating a radio resource by using the RTS frame and the CTS frame is stopped. When a terminal receives the CTS frame in which a value of the Number of Available PHY interface field 640 is set to 0, the terminal reconfigures an NAV and transmits uplink data in next TXOP.

If the value of the Number of Available PHY interface field 640 included in the CTS frame is not 0, a VHT non-AP STA can persistently transmit the RTS frame to a VHT AP STA. In this case, a contention-based channel access scheme is applied between the STAs. The contention-based channel access scheme implies an enhanced distributed channel access (EDCA) backoff mechanism. The EDCA backoff mechanism is one of contention-based channel access schemes. In this mechanism, a frame having priority between users is allowed for differentiated medium access so as to provide a specific time for transmitting a frame by a specific STA and to provide TXOP for ensuring the specific time.

The number of available PHY interfaces means the number of PHY interfaces that can be allocated by the VHT AP STA to the VHT non-AP STA, and indicates an amount of remaining resources. A system throughput can be maximized by minimizing the amount of remaining resources.

The SDMA TXOP duration indicates a duration of uplink TXOP.

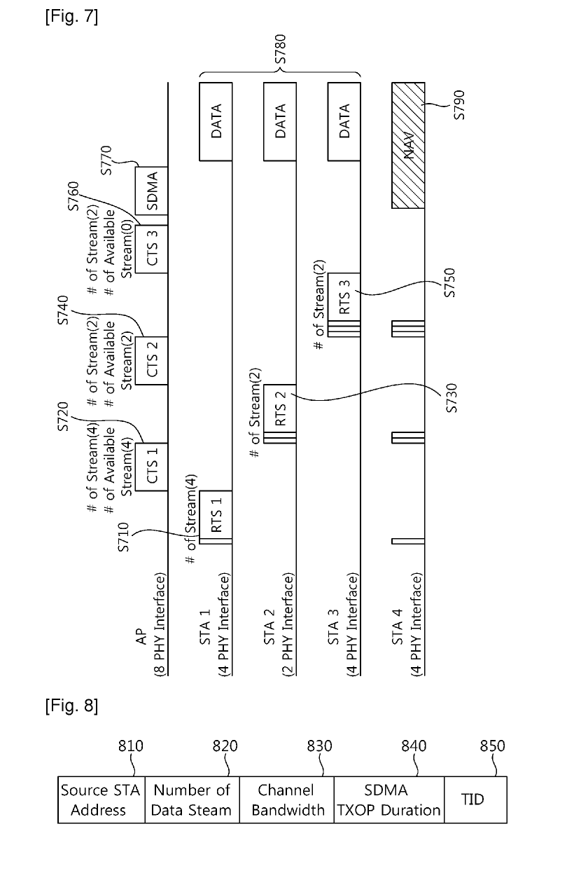

FIG. 7 shows a method of allocating a radio resource for uplink transmission and a method of transmitting a data stream according to another embodiment of the present invention.

To perform uplink transmission simultaneously by several STAs by using an SDMA scheme, the STAs may perform contention-based channel access. Therefore, the STAs transmit an RTS frame to an AP, and receive a CTS frame. The AP and the STAs may transmit the RTS frame, the CTS frame, etc., in a unicast, multicast, or broadcast manner.

As described above, the RTS frame may include information indicating an address of a source STA that transmits the RTS frame, information indicating an address of an AP that is a destination STA for receiving the RTS frame, information indicating the number of data streams to be transmitted by the STA, information indicating a channel bandwidth to be used when the data stream is transmitted, etc.

Upon receiving the CTS frame from the AP, the STA can simultaneously transmit to the AP the data streams of which number corresponds to a value of a Number of Al-locating PHY Interface field included in the CTS frame.

It is assumed that the AP has 8 PHY interfaces and a total of 4 STAs contend to transmit uplink data to the AP. The STAs are indicated by STA 1, STA 2, STA 3, and STA 4.

The STA 1 has 4 PHY interfaces and intends to transmit 4 data streams in uplink. The STA 2 has 2 PHY interfaces, and intends to transmit 2 data streams. The STA 3 has 4 PHY interfaces, and intends to transmit 2 data streams. The STA 4 has 4 PHY interfaces.

After a backoff time elapses, the STA 1 transmits an RTS frame 1 (S710). The number of data streams included in the RTS frame is set to 4. As described above, the STA 1 reports that 4 data streams are simultaneously transmitted to the AP, which requests allocation of corresponding radio resources.

The AP accepts the request of the STA 1, and thus transmits a CTS frame 1 (S720).

A value of a Number of PHY Interface field included in the CTS frame 1 is set to 4 by the AT. This implies that 4 out of 8 PHY interfaces occupied by the AP are allocated to the STA 1. Therefore, the Number of Available Stream field included in the CTS frame 1 is set to 4. This implies that 4 PHY interfaces can be allocated afterwards.

The STA 2 transmits an RTS frame 2 (S730). A value of a Number of Data Stream field is set to 2 in the RTS frame 2 transmitted by the STA 2. That is, the STA 2 intends to transmit two data streams. The AP transmits a CTS frame 2 in response to the RTS frame 2 (S740). A value of a Number of Allocating PHY interface field is set to 2 according to radio resource allocation information of the CTS frame 2. Since the AP has two available PHY interfaces remained unallocated after being allocated to the STA 2, a value of a Number of Available PHY Interface field is set to 2 in the CTS frame 2.

To transmit a data stream, the STA 3 transmits an RTS frame 3 to the AP (S750).

The STA 3 intends to transmit two data streams, and thus the number of data streams is set to 2 in the RTS frame 3. The AP transmits a CTS frame 3 to the STA 3 in response to the RTS frame 3 (S760). Until now, a value of an Available PHY interface field is set to 2 in the CTS frame 3 transmitted by the AP. The AP allocates two PHY interfaces to the STA 3. That is, a value of a Number of Allocating PHY interface field is set to 2, wherein this value depends on radio resource allocation information transmitted by being included in the CTS frame 3. Accordingly, a value of the Number of Available PHY Interface field is 0.

Subsequently, by transmitting an SDMA information frame, the VHT AP STA can transmit again information indicating a channel bandwidth and a PHY interface allocated to each VHT non-AP STA for uplink transmission (S770). Transmission of the SDMA information frame is an optional feature for optimizing system performance or radio resource utilization. Then, data is broadcasted or multicasted to the STA1, the STA2, and the STA3 (S780).

Herein, the CTS frame 3 is broadcast or multicast, and thus the STA 4 also receives the CTS frame 3 in which a value of the Number of Available PHY interface field is set to 3. Then, although there is a data stream desired to be transmitted, the STA 4 reconfigures an NAV instead of transmitting an RTS frame (S790).

FIG. 8 shows an example of an SDMA information frame transmitted in the embodiment shown in FIG. 4 or FIG. 7.

SDMA information for uplink transmission may have a format of the SDMA information frame. The SDMA information frame may include a Source STA Address field 810, a Number of Data Stream field 820, a Channel Bandwidth field 830, an SDMA TXOP Duration field 840, a Data Traffic Type field 850, etc.

The Source STA Address field 810 indicates MAC address information of an STA for receiving the SDMA information frame and for transmitting an uplink data stream. The Number of Data Stream field 820 indicates the number of data streams to be simultaneously transmitted in uplink from the STA to an AP. That is, the Number of Data Stream field 820 indicates the number of TX interfaces.

Therefore, by using the Number of Data Stream field 820, the STA can know a radio resource (i.e., the number of PHY interfaces) to be used to transmit a data stream to the AP. The Channel Bandwidth field 830 includes information indicating a channel bandwidth to be used to transmit the data stream in uplink to the AP. The SDMA TXOP Duration field 840 indicates a duration of uplink TXOP. The Data Traffic Type field 850 includes a traffic type or a traffic indication (TID) value of an uplink data stream. If the Data Traffic Type field indicates Action Category_Voice (AC_VO), data having a traffic type of AC_VO is transmitted in uplink by the STA.

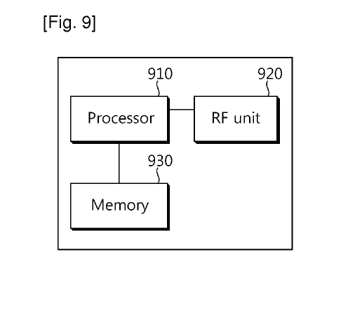

FIG. 9 is a block diagram of a terminal for performing a radio resource allocation method according to an embodiment of the present invention. The aforementioned STAs may be an example of the terminal of FIG. 9.

The terminal includes a processor 910 and a radio frequency (RF) unit 920. A memory 930 is coupled to the processor 910 and stores a variety of information to drive the processor 910. The memory 930 may include a read-only memory (ROM), a random access memory (RAM), a flash memory, a memory card, a storage medium, and/or other equivalent storage devices. In addition thereto, a wireless communication apparatus may further include a display unit or a user interface. The display unit or the user interface is not depicted in FIG. 9, and detailed descriptions thereof will be omitted.

The processor 910 may include an application-specific integrated circuit (ASIC), a separate chipset, a logic circuit, and/or a data processing unit. The processor 910 generates a control signal or data, in particular, an RTS frame or a data stream, to be transmitted to another STA or AP. Information indicating the number of data streams to be transmitted and information indicating an amount of radio resources to be allocated can be generated. Transmitting of this information by including the information in the RTS frame is included in one embodiment of the present invention.

The RF unit 920 is coupled to the processor 910. The RF unit 920 transmits a radio signal generated by the processor 910, and receives a radio signal transmitted by another wireless communication apparatus. The RF unit 920 may include a baseband circuit for processing the radio signal. Signals can be transmitted in a broadcast or unicast manner. It is assumed that multiple antennas are supported in a method of allocating a radio resource according to an embodiment of the present invention and a terminal for transmitting a data stream by using the method. The RF unit 920 may transmit a plurality of data streams to each STA through several antennas. Further, the RF unit 920 receives a CTS frame, SDMA information, etc., from an AP.

When the RF unit 920 receives radio resource allocation information from the AP, the processor 910 may control transmission of a data stream or reconfigure an NAV.

All functions described above may be performed by a processor such as a microprocessor, a controller, a microcontroller, an application specific integrated circuit (ASIC), or a process of a terminal illustrated in FIG. 3 according to software or program code for performing the functions. The program code may be designed, developed, and implemented on the basis of the descriptions of the present invention, and this is well known to those skilled in the art.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1.-12. (canceled)

13. A method of transmitting feedback information in a wireless local area network, comprising:
receiving, by a responding station, space division multiple access (SDMA) information for a SDMA transmission from a requesting station, the SDMA information including an address field and a first number field, the address field indicating the responding station, the first number field indicating a first number of spatial streams; and
transmitting, by the responding station, feedback information to the requesting station,
wherein the feedback information includes channel information in accordance with the first number of spatial streams.

14. The method of claim 13, wherein the feedback information further includes a second number field indicating a second number of spatial streams which is equal to the first number of spatial streams.

15. The method of claim 14, wherein the feedback information further includes a bandwidth field indicating a bandwidth which is used to receive the SDMA information.

16. The method of claim 15, wherein the SDMA information further includes a duration field which indicates an estimated time required for the responding station to transmit the feedback information.

17. A wireless apparatus of transmitting feedback information in a wireless local area network, comprising a processor configured to:
receive space division multiple access (SDMA) information for a SDMA transmission from a requesting station, the SDMA information including an address field and a first number field, the address field indicating the wireless apparatus, the first number field indicating a first number of spatial streams; and
transmit feedback information to the requesting station,
wherein the feedback information includes channel information in accordance with the first number of spatial streams.

18. The wireless apparatus of claim 17, wherein the feedback information further includes a second number field indicating a second number of spatial streams which is equal to the first number of spatial streams.

19. The wireless apparatus of claim 18, wherein the feedback information further includes a bandwidth field indicating a bandwidth which is used to receive the SDMA information.

20. The wireless apparatus of claim 18, wherein the SDMA information further includes a duration field which indicates an estimated time required for the responding station to transmit the feedback information.

21. A method of transmitting data for a plurality of stations in a wireless local area network, comprising:
transmitting space division multiple access (SDMA) information to the plurality of stations, the SDMA information including a plurality of SDMA frames, each of the plurality of SDMA frames including an address field and a first number field, the address field indicating each of the plurality of stations, the first number field indicating a first number of spatial streams for the corresponding station;
receiving feedback information from each of the plurality of stations, and
transmitting data based on the feedback information to at least one station of the plurality of stations;
wherein the feedback information includes channel information in accordance with the first number of spatial streams.

22. The method of claim 21, wherein the feedback information further includes a second number field indicating a second number of spatial streams which is equal to the first number of spatial streams.

23. The method of claim 22, wherein the feedback information further includes a bandwidth field indicating a bandwidth which is used by each station to receive the SDMA information.

24. The method of claim 23, wherein the SDMA information further includes a duration field which indicates an estimated time required for each station to transmit the feedback information.

25. A wireless apparatus of transmitting data for a plurality of stations in a wireless local area network, comprising a processor configured to:
transmit space division multiple access (SDMA) information to the plurality of stations, the SDMA information including a plurality of SDMA frames, each of the plurality of SDMA frames including an address field and a first number field, the address field indicating each of the plurality of stations, the first number field indicating a first number of spatial streams for the corresponding station;
receive feedback information from each of the plurality of stations, and
transmit data based on the feedback information to at least one station of the plurality of stations;
wherein the feedback information includes channel information in accordance with the first number of spatial streams.

26. The wireless apparatus of claim 25, wherein the feedback information further includes a second number field indicating a second number of spatial streams which is equal to the first number of spatial streams.

27. The wireless apparatus of claim 26, wherein the feedback information further includes a bandwidth field indicating a bandwidth which is used by each station to receive the SDMA information.
